(19) United States
(12) Patent Application Publication
(10) Pub. No.: US 2014/0274564 A1
(43) Pub. Date: Sep. 18, 2014

(54) DEVICES, SYSTEMS AND METHODS FOR INTERACTION IN A VIRTUAL ENVIRONMENT

(71) Applicant: Eric A. Greenbaum, Great Neck, NY (US)

(72) Inventor: Eric A. Greenbaum, Great Neck, NY (US)

(21) Appl. No.: 14/217,098

(22) Filed: Mar. 17, 2014

Related U.S. Application Data
(60) Provisional application No. 61/798,485, filed on Mar. 15, 2013.

(51) Int. Cl. A63B 24/00; A63F 13/40; A63B 22/06

(52) U.S. Cl. CPC A63B 24/0087; A63B 22/0605; A63F 13/10
USPC 482/5

(57) ABSTRACT

The present disclosure provides a systems devices and methods for an exercise gaming platform particularly suited for multiple users. The exercise gaming platform has a variable resistance exercise device operatively coupled to a virtual reality environment rendered by a computer such that user exercise motion on the variable resistance exercise device translates to movement of an avatar representing the user in the virtual reality environment and wherein the virtual reality environment has collision objects capable of a collision with the avatar representing the user in the virtual environment, and wherein the collision of a collision object with the avatar representing the user in the virtual environment causes the resistance level of the user's variable resistance exercise device to change. Also disclosed are methods for providing power to virtual machines and methods for procedurally generating virtual terrain changes in response to changes of resistance on a variable resistance exercise device.

### STATEMENT REGARDING FEDERALLY SPONSORED RESEARCH

N/A

### FIELD OF THE INVENTION

The present invention relates to devices, systems and methods for interacting in a virtual environment, particularly involving exercise and exergaming.

### BACKGROUND OF THE INVENTION

Video games have been a popular activity for decades. The rewarding features of video games make them appealing to many different demographics. While once the typical video game aficionado was a teenage male, video games now have much wider demographic penetration. Networked video games, for example massively multiplayer online role playing games (MMORPGs), such as World of Warcraft allow remotely situated players to play together in a networked virtual environment.

Virtual and augmented realities allow users to enjoy experiences otherwise not possible in the real world. The invention of 3D head mounted displays (hereinafter “HMD”) that inexpensively and convincingly bring users into rendered 3D environments has opened up a new world of human computer interaction. The rise of commercially viable HMDs have resulted in various new uses for virtual reality technology. Uses for HMDs include gaming, watching movies, working, surfing the web, exercising, rehabilitation, psychological treatment and varied others.

Obesity is a major epidemic in modern industrialized societies. As of this writing, one third to one half of the American population is estimated to be obese. Exercise is a critical part of maintaining a healthy weight. The use of variable resistance exercise or movement devices (“VRMD”) such as exercise bicycles, ellipticals, hand bikes and the like, both in gyms and peoples' homes is a popular form of exercise. VRMD's offer the advantages of low impact on user's joints, weather independence, and the ability to track output and user performance. One issue with these stationary machines is that they can be boring. To combat this boredom, people often listen to music or watch TV as they utilize these machines.

The idea to combine exercise with video gaming has been explored in the past. In fact several issued patents and pending applications discuss various rudimentary aspects of this technology, hereinafter referred to as “exergaming.” Nevertheless, the rise of virtual reality technology in combination with advances in videogame technology, particularly networked videogames has opened up new horizons and uncovered unmet needs in the field. To address some of the unmet needs in the field, the following application for patent is presented.

### SUMMARY OF THE INVENTION

In an embodiment the invention is a virtual reality exercise videogame comprising a virtual reality environment (“VE”). The VE further comprising at least one avatar representing at least one user in the VE, the virtual reality environment further comprising at least one collision object, and wherein the virtual reality environment further comprises collision detection, capable of detecting at least one collision between the at least one collision object and the at least one avatar representing at the least one user and/or at least one collision between the at least one collision object with another at least one collision object and/or at least one collision between the at least one collision object and the virtual reality environment; wherein the movement of the at least one avatar in the virtual environment is mediated, at least in part, by user input on a variable resistance exercise device, the variable resistance exercise device further comprising a resistance; and wherein an at least one collision between the at least one collision object and the at least one avatar results in a change in the resistance on the variable resistance exercise device.

In another embodiment, the invention is a system for exercising in a virtual reality environment comprising: at least one variable resistance exercise device for accepting at least one user exercise input, the at least one variable resistance exercise device having a resistance setting, the at least one variable resistance exercise device operatively coupled to a virtual reality environment rendered by a computing device such that at least one user exercise input on the variable resistance exercise device translates to movement of at least one avatar representing the at least one user in the virtual reality environment; and wherein the virtual reality environment further comprises at least one collision object capable of a collision with the at least one avatar representing the at least one user in the virtual reality environment; and wherein the collision of the at least one collision object with the at least one avatar representing the at least one user in the virtual reality environment causes the resistance setting of the at least one variable resistance exercise device to change.

In another embodiment, the invention is a stationary exercise station comprising: a computer, the computer rendering a virtual reality environment, the virtual reality environment further comprising at least one avatar representing an at least one user, the virtual reality environment further comprising at least one collision object, the virtual reality environment further comprising collision detection capable of detecting at least one collision in the virtual reality environment; a display in communication with the computer; an exercise device capable of receiving exercise input from the at least one user, the exercise device further comprising a variable resistance mechanism, the variable resistance mechanism providing a resistance to the exercise input from the at least one user, the resistance having a magnitude, the magnitude of the resistance being controlled by the computer rendering the virtual reality environment; and wherein a collision of the at least one avatar with the at least one collision object in the virtual reality environment cause the computer to alter the magnitude of the resistance of the variable resistance mechanism providing the resistance to the exercise input from the user.

In another embodiment, the invention is a method for providing virtual power to virtual machines in a virtual environment.

In another embodiment, the invention is a method for procedurally generating terrain in a virtual environment in response to changes in resistance on a variable resistance exercise device.

### BRIEF DESCRIPTION OF THE DRAWINGS

FIG. 1 shows a schematic view of the components of the exergaming system showing the various components of the variable resistance exercise device and the computer

FIG. 2 shows a flow diagram of the interactions between users, the variable resistance exercise device, the computer and the virtual environment

FIG. 3 shows a flow diagram illustrating user-user interaction in the virtual environment and how those interactions affect resistance on the users' variable resistance exercise devices

FIG. 4 shows a flow diagram depicting the steps for providing power to a virtual machine

FIG. 5 shows a flow diagram for procedurally generating graded terrain in response to changes of resistance on a variable resistance exercise device

FIG. 6 shows a recumbent exercise device suitable for use as the variable resistance exercise device and how it may be mounted on a movable platform to increase immersion

### DETAILED DESCRIPTION

In an embodiment the invention is a virtual reality exercise videogame comprising a virtual reality environment (“VE”). The VE further comprising at least one avatar representing at least one user in the VE, the virtual reality environment further comprising at least one collision object, and wherein the virtual reality environment further comprises collision detection, capable of detecting at least one collision between the at least one collision object and the at least one avatar representing at the least one user and/or at least one collision between the at least one collision object with another at least one collision object and/or at least one collision between the at least one collision object and the virtual reality environment; wherein the movement of the at least one avatar in the virtual environment is mediated, at least in part, by user input on a variable resistance exercise device, the variable resistance exercise device further comprising a resistance; and wherein an at least one collision between the at least one collision object and the at least one avatar results in a change in the resistance on the variable resistance exercise device.

In another embodiment, the invention is a system for exercising in a virtual reality environment comprising: at least one variable resistance exercise device for accepting at least one user exercise input, the at least one variable resistance exercise device having a resistance setting, the at least one variable resistance exercise device operatively coupled to a virtual reality environment rendered by a computing device such that at least one user exercise input on the variable resistance exercise device translates to movement of at least one avatar representing the at least one user in the virtual reality environment; and wherein the virtual reality environment further comprises at least one collision object capable of a collision with the at least one avatar representing the at least one user in the virtual reality environment; and wherein the collision of the at least one collision object with the at least one avatar representing the at least one user in the virtual reality environment causes the resistance setting of the at least one variable resistance exercise device to change.

In another embodiment, the invention is a stationary exercise station comprising: a computer, the computer rendering a virtual reality environment, the virtual reality environment further comprising at least one avatar representing an at least one user, the virtual reality environment further comprising at least one collision object, the virtual reality environment further comprising collision detection capable of detecting at least one collision in the virtual reality environment; a display in communication with the computer; an exercise device capable of receiving exercise input from the at least one user, the exercise device further comprising a variable resistance mechanism, the variable resistance mechanism providing a resistance to the exercise input from the at least one user, the resistance having a magnitude, the magnitude of the resistance being controlled by the computer rendering the virtual reality environment; and wherein a collision of the at least one avatar with the at least one collision object in the virtual reality environment cause the computer to alter the magnitude of the resistance of the variable resistance mechanism providing the resistance to the exercise input from the user.

Virtual Reality Environment: Various virtual reality environments and game environments (collectively referred to hereinafter as “VE”) are suitable for use with the systems, devices and methods described herein. Of particular interest are those VEs built in videogame building programs (engines) such as, by way of a non limiting example, the Unity brand development platform, the Unreal Development Engine, CryEngine and the like. The Unity development platform and its ilk allow developers to build and render immersive 3D virtual environments limited only by the developers imagination. To create an enjoyable experience for users the VE will contain various assets. Assets include terrains, 3d models of real world or fictitious objects, vehicles and the like. Terrains in the VE may have a grade, such as an uphill grade or a downhill grade. Terrain based resistance schema, known in the art may be included such that movement of an avatar on an uphill grade would cause an increase in resistance while movement on a downhill grade may cause a decrease in resistance. VEs may be built with rules defining various physical properties (physics) such as gravity, collision detection, and the like. The physics of the VE may be similar to real world physics or may have other physics properties defined by developers to give users a more enjoyable experience. VE's may contain terrain elements such as a landscape or an “infinite” or procedurally generated terrain. VE's may also contain various props built within the game design program or imported from other 3d modeling software. By way of non limiting example, non player characters or other features of the virtual environment (such as towers and the like) may be equipped with virtual projectile launchers under the control of an artificial intelligence AI that is programmed to shoot at the users' avatars.

Computer: Generally speaking, the VE will be instantiated or rendered by a computing device or a computer. The computers used to render the VE may be local machines or accessed in the “cloud.” For multi user play, more than one computer may be networked together either locally such as for example in a Local Area Network (LAN) or widely such as for example a Wide Area Network (WAN). However, a single computer may also be used to host the VE and various users could couple to the single computer to gain access to the VE.

Avatar: A character controller element is placed within the VE and serves as the representation of the user in the VE, allowing the user to move about the VE and interact with the various assets in the VE, with the VE itself and other users represented in the VE. The character controller may further comprise an avatar which is the virtual physical representation of the user in the VE. Character controllers may represent the user in the VE according to several modalities known to those having skill in the art such as a First Person Perspective, a Third Person Perspective, A Vehicle, A First Person Perspective coupled to a Vehicle Perspective such as a “cockpit view,” various combinations of the above and the like. Avatars may have physical properties in the VE allowing them to come into contact with other avatars, the VE, objects in the VE, VE assets and the like. An outer contact surface of the avatar may be represented by a collider object such as a collision mesh in the exact shape of the avatar or a 3 dimensional shape overlaying the avatar such as a sphere, rectangle, capsule and the like.

Users: The devices, systems and methods disclosed herein are meant to be used by single users in a single player mode or multiple users in a multiplayer mode. In the single player mode, a single user will interact with the VE and the assets contained therein such as the terrain, props, non-player characters and the like. Muliplayer functionality can be added to the environment allowing multiple users to be in the VE at the same time and to engage in multiplayer mode. In multiplayer mode, various sub-modes can be provided such as player vs. player and cooperative mode. In player vs player mode, various players may play against each other such as by racing, shooting each other and the like. In cooperative mode, the players work together in the VE and against non player characters, or other teams of cooperating players. Due to the nature of the VE, users do not necessarily need to be in the same physical location to be in the same VE. In fact, users in remote locations can be in the same VE at the same time by incorporating network functionality well known to those skilled in the art.

In practice, users will engage the variable resistance exercise device and apply exercise input. The way the users engage the variable resistance exercise devices and apply exercise input will vary as a function of the type of variable resistance exercise device used. For example, if the variable resistance exercise device used is a recumbent exercise bike, the user will sit in the seat of the recumbent exercise bike and place his or her feet on the recumbent bike's pedals. In this example the user would provide exercise input by pedaling the recumbent exercise bike. In the case of an elliptical machine, the user would stand on the platforms or pedals of the elliptical machine and provide exercise input by practicing the ellipticizing motion familiar to users of elliptical machines. Other forms of engagement and exercise input are well known to those skilled in the art.

Collision Detection: Collision detection, especially with respect to videogames refers to the mechanism by which a computer program recognizes when 2 or more virtual objects intersect. Various collision detection schema are well known to those having skill in the art. In fact, collision detection physics are often integrated into the computer programs used to construct virtual reality and other videogame environments. The Unity development platform, for example has collision detection functionality as part of its system. Typically, objects in a virtual environment are assigned a collision mesh that defines the surface of the of the object capable of having a collision with other objects in the virtual environment. The collision mesh of the objects in the virtual environment may correspond to the surface of the model of that object in the virtual environment or the collision mesh may be arbitrarily assigned to the object. For example, in a first-person-controller model, meant to simulate a first person view of the virtual environment from the point of view of an avatar representing a user in the virtual environment, the collision mesh of the first person controller is often assigned a capsule shape roughly 2 virtual meters high.

Collision Objects: Objects present in a virtual environment may or may not be collision objects. A collision object for the purposes of this application is any object, present in a virtual environment that will cause to be registered a collision when it comes into contact with any other object in the virtual environment. Typically to be a collision object, the object in the virtual environment must be assigned as a collider or have a collision mesh assigned to it. In this case, the virtual environment would be populated by a variety of collision objects. Some non limiting examples of collision objects present would be paths, roads, terrains, trees, props, virtual projectile launchers, virtual projectiles, power ups, power downs, avatars, vehicles, and the like. Virtual Projectile launchers that launch virtual projectiles are particularly contemplated. Virtual Projectile Launchers such as video game weapons are well known in the art and their programming and operation are also well known.

Avatar Movement: Users may control the movement or apparent movement of their avatars in the VE by any methods known to those having skill in the art such as, for example, keyboard input, game pad input, input from motion capture devices and the like. Of particular interest for the present case, is control input mediated at least in part from variable resistance exercise devices such that user exercise input into the exercise device would translate into avatar movement in the VE. This can be accomplished by causing a sensor on the VRMD to communicate with the computer rendering the virtual environment. Input derived from user exercise input may be supplemented with additional control schema such as keyboard, joystick, game pad or other control schema known to those having skill in the art. For example, forward and backward motion would be controlled by user exercise input while steering would be controlled by an analog control stick, or by moving handlebars on the VRMD, and firing virtual projectiles would be controlled by a button push on a keyboard, game pad, nunchuck style controller or the like.

Variable Resistance Exercise Device: A wide variety of exercise equipment known to those having skill in the art or later invented would be suitable to serve as the variable resistance exercise (or movement) device, (hereinafter “VRMD”), such as, for example exercise bikes, steppers, elliptical machines, cross country ski machines, treadmills, mini exercise bikes, hand bikes, rail car machines, rowing machines, or a combination of the above. The VRMD is capable of accepting user exercise input. They type of user exercise input will vary depending on the specific type of exercise device used. For example, an exercise bike will accept pedaling input, an elliptical machine will accept ellipticizing input, and the like. User exercise input to the VRMD may cause the movement of a drive train mechanism. The exercise device may include a flywheel that is caused to rotate via user input via drive train mechanism.

A resistance mechanism may be coupled to VRMD such that various levels of resistance can be exerted against user exercise input. For example, the resistance mechanism may be coupled to the flywheel to give variable resistance to the flywheel, such as, for example an eddy current brake positioned proximate to the flywheel or a mechanical resistance mechanism, or a combination of these mechanisms or other mechanisms known to those having skill in the art. The resistance mechanism is operatively coupled to a controller that controls the level of resistance to user exercise input.

The VRMD, also includes a sensor or a monitoring system for determining the magnitude and or intensity of user exercise input. For example a sensor may measure flywheel speed and power output by the user. Additional sensors may be part of the VRMD such as heart rate monitoring. VRMDs that include such monitoring features will also include an output mechanism to communicate the monitoring (sensor) data either to a stand alone display console, such as the a controller, or to a computer.

For a detailed description of an exercise bike suitable for incorporation into this system, please see U.S. Pat. No. 8,585,561, herein incorporated by reference in its entirety. In particular attention is drawn to FIGS. 1, 2, 3, 5, 9, 10, 11, 12, 13, 14, and the associated written description. Attention is also drawn to Expresso brand and Lifecycle brand exercise bicycle systems for further information on, user output monitoring (RPM, power, etc) automatic resistance control and terrain-based resistance schemes.

Collisions Result in Changes in Resistance: Collisions in a virtual environment may have various consequences for the collision objects. The consequences of such collisions will depend on the properties of the collision objects involved. In a typical videogame example, an avatar will be imbued with a “health” property, such as health ranging from 0-100%. Collision with a detrimental object such as a virtual bullet will result in a decrease in health while collision with a beneficial object such as a power up will result in an increase in health.

In this case, collisions with collision objects would be defined to affect the resistance of the VRMD. Broadly speaking collisions with collision objects may be generally defined as beneficial or detrimental. Beneficial collisions would result in decreases in resistance while detrimental collisions would result in increased resistance. Specific increases/decreases in resistance would be assigned to the various collision objects or classes of collision objects such that a collision would result in a pre-programmed increase or decrease in resistance.

In practice the elements described above may be integrated to form fully functional system for exergaming. For example, in a prototype of the system, a VE was built which included a mountainous terrain element with uphill grades and downhill grades, a path element, various decorative elements such as trees, grasses, path textures, rocks, buildings and the like. 2 wheeled vehicle avatars were added to the VE such that users would be represented by these avatars in the VE. The 2 wheeled vehicles were equipped with virtual projectile launchers in the form of lasers coupled to the front of the 2 wheeled vehicles. Character controller elements were added to the avatars such that the users were able to control the movement of the avatars in the VE as well has having control of the virtual projectile launchers coupled to the vehicles. VRMDs were operatively coupled to the computer rendering the VE such that the sensors on the VRMDs communicated user exercise input to the computer and the computer translated the sensor data into avatar movement in the VE. Users were also equipped with a nunchuck style controller which had an analog joystick and several buttons. The nunchuck joystick was mapped to the character controllers such that movement of the analog joystick steered the avatars in the VE and a button press on the nunchuck style controller caused the firing of the virtual projectile launcher. Collision detection was enabled in the VE. The resistance controller of the VRMD was in communication with the computer rendering the VE such that collisions detected in the VE could be communicated to the resistance controller so as to alter the resistance of the VRMD. Projectiles from the virtual projectile launcher were defined as detrimental collision objects such that getting “hit” by one of these virtual projectiles would cause a 10% increase in the magnitude of the resistance on the VRMD for 15 seconds. Each hit would cause another 10% increase in resistance up to a maximum of 75% resistance on the VRMD. Power Up collision objects were also added to the VE in the form of glowing crystals on the path. Power Up collision objects were defined as beneficial collision objects and would cause a 10% decrease in resistance on the VRMD for a period of 10 seconds.

Turning now to FIG. 1. FIG. 1 shows a schematic view of the components of the exergaming system showing the various components of the variable resistance exercise device 101 and the computer 102. The variable resistance exercise device 101 is made up of at least the following components: an exercise input component 103 such as pedals on an exercise bike, platforms on an elliptical machine, platforms on a stepper or the like, coupled to a drive train mechanism which may include a flywheel; a sensor component 104 for detecting the magnitude of user exercise input, such as, for example by measuring the heart rate of a user and/or measuring the rotations per minute of a flywheel; a resistance mechanism 106 is operatively coupled to the exercise input component such that a variable amount of resistance can be applied to a user's exercise input; a controller component 105 operatively coupled to the sensor and resistance mechanism accepts sensor data from the sensor component 104 and outputs the sensor data; the controller component also communicates with the resistance mechanism and alters the resistance level to user exercise input based on input from the user or from the computer 102. The computer 102 provides at least the following: rendering of the virtual environment 107; providing character control for avatar motion in the virtual environment; collision detection; rendering avatars in the virtual environment; rendering collision objects in the virtual environment. The computer 102 sends output signals to the controller 105 to indicate when resistance should be altered in response to changes in terrain and/or detected collisions in the virtual environment between avatars and/or an avatar and a collision object. The computer 102 also accepts input signals from the controller 105 which in turn accepts input from the sensor 104 so that avatar motion in the virtual environment can be mediated by user exercise input on the variable resistance exercise device 101.

Turning now to FIG. 2. FIG. 2 shows a flow diagram of the interactions between at least one user, the variable resistance exercise device, the computer and the virtual environment. Initially the computer renders the virtual environment 201; computer accepts input from the user who provides exercise input to the VRMD 202; user provided exercise input mediates avatar movement in the virtual environment 203; computer determines if a collision is detected between an avatar and a collision object 204, if a collision is detected, computer determines if the collision is a beneficial or a detrimental collision 206; computer sends a signal to the VRMD indicating either a decrease or increase in resistance 205 depending on whether the detected collision is a beneficial or a detrimental collision; if no collision detection is detected no changes are made to the resistance level of the variable resistance exercise device.

Turning now to FIG. 3. FIG. 3 shows a flow diagram illustrating user-user interaction in the virtual environment and how those interactions affect resistance on the users' variable resistance exercise devices. The computer renders the virtual environment 307; users engage their respective variable resistance exercise devices 301 & 304 as in, for example, by sitting down on an exercise bike and placing their feet onto the pedals of the exercise bike, or mounting an elliptical machine, or the like; users enter the virtual environment 302 & 305, as in for example by putting on a head mounted display which displays the virtual environment to the user or by pressing a start button on a control interface such as a game pad; users exercise on the variable resistance exercise devices which mediates the movement of their avatars in the virtual environment 303 & 306 as in for example by having the sensor from the VRMD send signals to the computer indicating the magnitude of the users' exercise; users engage each other in the virtual environment, as in for example by racing on a race track in the virtual environment 308; the users may also engage each other with virtual projectile launchers, for example a first user (user 1) may shoot a second user (user 2) with a virtual projectile 309; computer detects the collision of the virtual projectile with the avatar of user 2 310, computer sends a signal to the controller of user 2's variable resistance exercise device indicating a detrimental collision 311; controller on user 2's variable resistance exercise device causes the resistance level of the resistance component of user 2's variable resistance exercise device to increase.

### A Method for Providing Power to Virtual Machines in a Virtual Environment

In an embodiment, the invention is a method for providing power to a virtual machine comprising: defining an energy requirement for a virtual machine; defining an exercise output quantity sufficient to meet the defined energy requirement of the virtual machine, determining whether the exercise output quantity sufficient to meet the defined energy requirement of the virtual machine has been met; providing power to the virtual machine if the exercise output quantity sufficient to meet the defined energy requirement of the virtual machine has been met; and providing notification to a user that the exercise output quantity sufficient to meet the defined energy requirement of the virtual machine has not been met if the exercise output quantity sufficient to meet the defined energy requirement of the virtual machine has been not been met. The method may further comprise the additional steps of providing secondary power options if the exercise output quantity sufficient to meet the defined energy requirement of the virtual machine has been exceeded. Secondary power option may include providing power to ancillary functions of the virtual machine such as weapons, shields, booster power, backup power and the like. The defined exercise output quantity may be defined with reference to a physiological benchmark of a user, such as, for example a user's heart rate. The defined exercise energy output quantity may be defined with reference to a state of the exercise device such as RPM, wattage produced, inferred speed or the like.

It may be desirable to have a less direct, abstracted, connection between the player's energy output on the exercise machine and power [energy] inside the VE. For example, any in-game (virtual) machine, may require a certain amount of in-game (virtual) power supply that would correspond to a certain amount of player output energy. A player may “power up” the in-game machine by doing real world exercise. The player's individual characteristics could be taken into account when converting real world energy output to in-game power. For example, the machine may require energy equivalent to some percentage of the user's maximum heart rate, based on the user's age, weight and other physical characteristics.

Hybrid approaches may also be utilized. For example a player may “charge” his/her machine via movement on the VRMD for a period of time to create minimum amount of “stored” energy in the in-game machine, but the player may have to continue to input energy through pedaling in order to power in-game weapons or for increased speed or the like.

By way of example, in an embodiment the virtual vehicle may be a flying machine such as a helicopter or a hovercraft. In order to provide energy to power the helicopter, the user will pedal the recumbent bike. The power needs of the helicopter may be defined with reference to the user. For example, the helicopter may require the power output required to keep the user's heart rate at a defined value. For example 80% maximum heart rate based on physiological variables of the user. In this way users of various ages, fitness levels etc could be normalized against each other. Alternatively, the power requirement for the in-game vehicle could be based on an absolute value such as wattage produced by the exercise device or RPM of the flywheel of a VRMD. Additional energy supplied by the user surpassing the minimum requirements needed to power the vehicle may be used for powering in-game weapons, shields or the like. In the circumstance when a user has a surplus of energy stored, weapons hits from other players, NPCs or other in-game elements may decrease the surplus energy before causing an increase in resistance.

Turning now to FIG. 4. FIG. 4 shows a flow diagram depicting the steps for providing power to a virtual machine: the steps include at least defining an energy requirement for a virtual machine 401; defining an exercise output quantity sufficient to meet the defined energy requirement of the virtual machine 402; measuring exercise output on an exercise device 403; determining whether the exercise output is sufficient to meet the defined energy requirement of the virtual machine 404; providing power to the virtual machine if the exercise output quantity sufficient to meet the defined energy requirement of the virtual machine has been met 405; and providing notification to a user that the exercise output quantity sufficient to meet the defined energy requirement of the virtual machine has not been met if the exercise output quantity sufficient to meet the defined energy requirement of the virtual machine has been not been met 406; determining whether the exercise output exceeds the quantity sufficient to meet the defined energy requirement of the virtual machine 407 providing power to secondary power options if the exercise output exceeds the quantity sufficient to meet the defined energy requirement of the virtual machine 408; and providing notification to a user that the exercise output quantity is not sufficient to provide secondary power options if the exercise quantity does not exceed the quantity sufficient to meet the defined energy requirement of the virtual machine 409.

### Procedural Generation of Virtual Environments Dictated by Preset Programs or “Tracks” Included on a Variable Resistance Exercise Device

Thus far there has been discussed communication from the VE to the VRMD such that interactions within the VE cause changes in resistance to the VRMD. However, this is not the only possibility. In fact, the direction of information flow can be reversed such that changes in the resistance of the VRMD can cause changes in the VE. Many VRMDs currently on the market come with preset resistance programs designed to give the user a good workout. In such cases, the user selects from a variety of presets resistance paradigms, sets the time for the workout, sets the overall level of the program and presses start to begin the program. The VRMD then alters the resistance (and sometimes the incline) of the VRMD in accordance with the rules of the preset program. An example program used by many of the VRMDs on the market is the “Hill” program in which the program begins by presenting the user with an initial low level of resistance, then increasing the resistance stepwise to a high level of resistance, then reducing the level of resistance stepwise back to a low level of resistance. This program is meant to mimic the user traveling up and down hills. The changes of resistance are carried out by having a computing device which stores the preset settings in its memory send a signal to the resistance assembly in the VRMD which causes the resistance control mechanism of the resistance assembly to changes the level of the VRMD's resistance. The output from the VRMDs computing device can also be sent to an input for the VE to change the rendering of the VE to match the preset's resistance settings. For example, when the VRMD's computing devices signals the VRMD resistance control mechanism, that signal can also be sent to the terrain generation engine of the VE. The terrain generation engine would then alter the grade of the VE to correspond to the change in VRMD resistance. This “real time” terrain generation/alteration can be accomplished by various means known to those skilled in the art. “Infinite Runner” style environments and “endless” environments are particularly useful VEs for this type of real time terrain generation. Infinite runner and endless environments generate VE elements on the fly to present the illusion of an infinite environment. Infinite runner environments utilize a stationary avatar and move the VE past the avatar, giving the illusion of forward motion. Endless environments cause the generation of terrain elements in the direction of the avatars movements. Various translations could be used to map resistance to grade of a VE, but as an example the following are useful as an example.

TABLE 1

| Resistance % | Grade (degrees) |
|---|---|
| 0 | −45 |
| 10 | −30 |
| 20 | −15 |
| 30 | −5 |
| 40 | 0-10 |
| 50 | 0-10 |
| 60 | 15 |
| 70 | 30 |
| 80 | 40 |
| 90 | 50 |
| 100 | 60 |

It may be desirable to scale down the grade incline/decline so that resistance 1-100% would map to between −30-30 degrees of incline. Other suitable translations may also be desirable to deliver an optimal user experience. The extent of grade variation may be tied to the degree of realism desired to be simulated to users.

Turning now to FIG. 5. FIG. 5 shows a flow diagram for procedurally generating graded terrain in response to changes of resistance on a variable resistance exercise device. Controller module of a variable resistance exercise device sends signal to the resistance mechanism of the VRMD to change the resistance level on the VRMD 501; the resistance mechanism on the VRMD changes the resistance level on the VRMD in response to the signal from the controller 502; the signal from the controller signalling a change in resistance can also be sent to the computer rendering a virtual environment 503, such as, for example by incorporating a second output from the controller and operatively coupling that second output to the computer rendering the VE; computer interprets the signal from the controller and translates the resistance level indicated by the controller to an appropriate grade of terrain in the virtual environment 504; computer alters the grade of the terrain of the virtual environment to correspond to the level of resistance on the VRMD 505.

### A Device for Interaction in a Virtual Environment

In an embodiment, the invention is a device for providing real world feedback from interactions in a virtual environment. For example the device may comprise a mechanism for interacting with a virtual environment and a mechanism for providing an exercise platform to a user, such as a variable resistance movement device (VRMD). Any variable resistance device or system may be employed. The inventor specifically contemplates the class of variable resistance movement devices which include exercise machines such as exercise bikes, elliptical trainers, treadmills, hand bikes and the like. The VRMD may further comprise an operative connection from the device to a virtual environment. This may include coupling to a computer, game console, web server or the like. The device may further comprise a user input component. The input component may be any input device known to those skilled in the art. For example, hand held game controllers, touch screens, joy sticks and the like. The input component may further comprise a means for capturing user motion, as in for example, the technology used in the Microsoft Kinect, or LEAP Motion sensor. The VRMD may further comprise an air movement component such as a fan. The fan will be operatively coupled to the virtual environment such that the speed of the air movement will correspond to in-game motion or other events. For example, as speed increases in the game, air movement over the user will increase. In addition, the air mover could move air at the user to simulate in-game wind. The air mover should be capable of rotation about at least 2 axes (up/down and left/right) to further simulate in-game movement or effects. The VRMD will further comprise a way to operatively connect to a display. Of particular emphasis is the class of displays known as head mounted displays. More particularly head mounted displays adapted to be used during exercise. The VRMD may be mounted on a rig to move the VRMD about different axis. Other displays such as video screens may be used. Hybrid displays such which incorporate immersive elements may also be employed, such as, for example, the DeepStream 3D viewer by FirstHand Technology.

The exercise device may further comprise a fan or other air mover to cause air to move over the player in response to in-game events. The fan may be operatively coupled to the computer such that the rate of air movement [speed of the fan] corresponds to in-game speed. For example as the player pedals faster [or ellipticizes or other exercise input], the speed of the fan would increase adding to the immersive nature of the experience. The fan may also be rotable on 2 axes (up-down & left-right) such that in-game turning or changes in attitude would cause corresponding movement of the fan to simulate movement in the in-game environment.

In addition to steady state increases/decreases of resistance, “choppy” or intermittent resistance could give the impression of uneven environments. This could be accomplished through any method known to those skilled in the art, as for example, those described above. Combinations of resistance mechanisms may be desirable such as, a magnetic resistance mechanism combined with a cantilever or other mechanical system. In this way rapid or choppy resistance changes can be accomplished with the mechanical mechanism while more steady resistance changes can be accomplished with the magnetic mechanism.

To improve the immersion aspect of the VE, the VRMD may responsively mounted to move in response to activity in the virtual environment. Those skilled in the art would recognize various motion simulator technologies that would be appropriate. For example patents/patent applications: Ser. No. 12/343,017, U.S. Pat. Nos. 6,315,673, 7,402,041, Ser. No. 10/844,460, EP 2215618 B1, herein incorporated by reference in their entirety, and the references cited in those patents/patent applications.

Turning now to FIG. 6. FIG. 6 shows a recumbent exercise bike suitable for use as the variable resistance exercise device and how it may be mounted on a movable platform to increase immersion. The recumbent bike variable resistance exercise device 601 will be made up of the following components: A seat to engage a user 602; a support structure 603; a joystick 604 to provide input control; the joystick 604 may have a trigger 606 and at least one additional button 605 for providing additional input such as, for example, for firing virtual projectiles from a virtual projectile launcher; a control panel 607, pedals 608, crank arms 609, a shroud 610 to cover moving parts of the drive train (not shown) and a resistance mechanism (not shown); the drive train may include a flywheel 611; a sensor (not shown) operatively coupled to the flywheel will measure the RPM of the flywheel and output the sensor data; a fan 615 or other air mover may be mounted to the recumbent bike to move air over the user. The recumbent bike 601 may be mounted to a simulator platform to move the recumbent bike 601 in response to events in the virtual environment. The simulator platform including a base 612; mounting arms 613; wherein the mounting arms 613 are operatively coupled to actuators 614 capable of moving the mounting arms and in turn moving the recumbent bike about in space.

### The Head Mounted Display

It is anticipated that the virtual environments will be displayed to user(s) using any methods known to those skilled in the art including screens and head mounted displays. Head mounted displays are particularly contemplated for the unprecedented immersion they confer. Head Mounted Displays used in the system may be any HMD known to those skilled in the art. Because the system is intended to be used during exercise, it may be desirable to have an HMD capable of dealing with perspiration and other sequelae of exercise such as the HMD described in co-pending PCT application No. PCT/US13/71547 herein incorporated by reference in its entirety.

### A Method for Providing Interaction in a Virtual Environment

In an embodiment, the invention is a method for providing real world feedback from interactions in a virtual environment. In particular, the invention relates to the use of changes in resistance on an exercise device such as a variable resistance movement device (VRMD). For example, a user on an VRMD will experience a certain amount of resistance against his or her movements. In-game interactions will change the resistance on the VRMD. Examples of in-game interactions that will cause changes in resistance may include, but are not limited to, going uphill/downhill, going off a path, going over obstacles or rough ground, increasing or decreasing altitude, flying through pockets of debris, going over or through water, getting struck by an in-game hazard such as a weapon, being hurt, running out of energy, gaining energy, getting a boost, reaching goals, failing to reach goals, and the like. Changes in resistance may be steady or choppy. The user's real world movements will have effects in the virtual environment (VE). For example, by moving faster on the VRMD the user's in-game representation or avatar will move faster.

The method may comprise the steps of providing a virtual environment for a user on a VRMD, wherein the user is represented in the virtual environment by an avatar or other appropriate representation, the virtual environment further may further comprise interaction elements; detecting when the user's avatar comes into contact with an interaction element in the virtual environment; sending a signal to the VRMD wherein the signal to the VRMD influences the resistance on the VRMD. Detecting when a user's avatar comes into contact with an interaction element may be accomplished using collision detection.

Detecting when the user's representation comes into “contact” with an interaction element can be accomplished through any of a number of methods known to those skilled in the art. Many video games and virtual environments are built using physics engines which incorporate “collision detection” functionality that is capable of providing the information on interactions occurring in the virtual environment. Adjusting the resistance on the VRMD may be accomplished through any method known to those skilled in the art, or later invented, for example with a eddy-current resistance system, particle brake system, cantilever brake system, combination thereof, or the like.

The virtual environment may also equip player with weapons or allow players to “pick up” items and use them to interact with other players. For example, a player's vehicle may be equipped with an appropriate video game weapon known to those having skill in the art such as “plasma blasters,” a coconut, or the like. In the game when one player fires on another player, the VE would register the hit via collision detection algorithms or other appropriate technique. When the in-game hit is registered, a signal will be sent to a controller on a VRMD, a corresponding change in the VRMD's resistance will occur. The mechanisms for registering “hits” are well known in the art and have been used for years to generate haptic feedback, as in for example “rumbles” on hand held controllers. Aim control of in game elements could be coupled to user head movement such that the aiming point follows the user's gaze or controlled by other input mechanisms known to those having skill in the art, such as, for example, game pads, “nunchuck” style controllers or the like.

Other in-game interactions may include providing “power up” items or locations, as for example, an in-game strip, or ring that the player traverses or picks up or otherwise interacts with, and obtains temporary special powers, like increased speed, which would be manifested by a decrease in resistance on the exercise device and/or increasing the in-game momentum/power from each movement on the VRMD.

### An Exercise Based Racing Game with Haptic Feedback

In an embodiment the invention is a racing game that provides real world feedback to its players. The virtual environment in which the game is rendered is operatively coupled to a VRMD. For example, a user on a VRMD, equipped with a display, such as a HMD adapted for use with exercise, and looking at a display of a virtual race course. User movement on the VRMD translates to movement in the virtual environment. Specifically, increased speed on the VRMD will translate into increased speed in the virtual environment. The virtual environment will further comprise in-game elements. For example, the VE of the racing game may further comprise a track, or race course. The track may be flanked by transition regions. The transition regions may be flanked by rough regions. The track may have various inclines or declines. The track may further comprise obstacles. the track may further comprise booster regions. Interaction with in-game elements will result in changes in resistance on the VRMD. Where appropriate, the VRMD may have features to imitate “incline.” For example, increasing stride length on an elliptical, tilt on a treadmill or exercise bike, or the like. For example, an in-game downward sloping grade would result in decreased resistance VRMD, going off the track onto the transition region would result in an increase in resistance. Going off the transition region into the rough region would result in a further increase in resistance. The race course may further comprise jumps or gaps over which the racers will travel. At the times the racers are “airborne” the resistance on the VRMD may drop to minimal level to mimic lack of resistance against a track. Players in the racing game may be equipped or acquire weapons, such as in-game projectiles for use against other players/racers. Getting hit by an in-game weapon will result in changes in VRMD resistance. Different weapons may have different resistance effects. For example, a low power weapon may increase resistance by 10%. A very powerful weapon may result in total lock up of the VRMD or an increase to 100% of the capable resistance, although total lock up may be undesirable as it may increase the probability of user injury. Changes in resistance may be steady or intermittent. For example some in-game weapons may result in random changes in resistance over a fixed time period. Some weapons may cause a rapid toggling between resistance levels. Weapons need not be fired only by other players, NPCs (non player characters) may be present and capable of firing weapons at players, unmanned weapons or falling projectiles/obstacles may be present that can have effects on VRMD resistance.

Changes in resistance may be used to simulate traction in the VE. For example, a track in a racing game may have a “muddy” or “sandy” patch that will result in a decrease in traction for the players in the game. In this example assume that the VRMD is an exercise bicycle. As players (or their avatars) are in contact with this muddy region, resistance levels on the VRMD may drop while simultaneously the movement translation function also drops. The result is that the player will experience decreased resistance in the pedals of the exercise bike allowing the player to rapidly cycle the pedals, yet at the same time each pedal turn results in less forward movement/momentum.

The racer in the first position may experience an increase in resistance and increased air movement to simulate having to move through the environment. Racers behind other racers may experience a decrease in resistance to simulate “drafting.” Collision with other racers may result in changes in resistance on the VRMD. For example, if the front of a racer comes up against the back of another racer, the racer in front may experience a decrease in resistance on the VRMD to simulate being pushed while the racer in back may experience an increase in resistance to simulate pushing against the other racer.

There is no reason why the real world motion must correspond to the type of motion in the virtual environment. For example, pedaling an exercise bike may result in walking or running in the virtual environment. Similarly, running on a treadmill or elliptical could result in vehicular motion such as a car movement or helicopter flight.

### An Exercise System for Virtual Reality

In an embodiment the invention is a system for exercise in a virtual environment. The system comprises a VRMD, a head mounted display and a virtual environment, where the VRMD and the HMD are operatively coupled to the virtual environment. The virtual environment may be a fully immersive virtual world networked such that remote users from all over the world are capable of logging into the environment and playing interactively together.

### A Method for Providing an Exercise Based Currency in a Virtual Environment

In an embodiment the invention is a method for providing a virtual currency based on real world exercise. Lack of exercise is a major societal issue. Systems and methods that encourage exercise may have substantial positive societal effects. Video games are now a major global industry with a broadening demographic appeal. Users engaged with virtual worlds spend substantial amounts of time and money in this engagement. For example they spend real world dollars to equip their avatars with clothes, vehicles, real estate and the like. The method comprises the steps of having a user exercise, monitoring the energetic output of the user's exercise, converting the energetic output of the user's exercise into currency units, providing an environment where a user can convert the currency units into in-game goods and/or services.

It is contemplated that real-world benefits may be contingent on providing exercise input into a VE. For example, tax credits or health insurance premiums may be reduced as a function of exercise input into the VE. The real life rewards could correlate with game-like elements for example, completing a 6 week, “daily bike tour of New England” game could result in a free month's insurance premium.

Exercise credits may also be used in VE as a form of currency. For example, a player may want to travel from one part of the VE to another. Because the VE is limited only by designers' imaginations, the actual method of in game travel could be anything from a bike ride to a teleportation device. Nevertheless the travel would have to be paid for with some form of in-game currency. In a simple example, the player would ride a bicycle across the in-game distance via real world movement on a VRMD. In a more abstracted system, the player would input a certain amount of energy through the VRMD and that exercise “input” would be converted into an in-game currency redeemable for traveling a certain in-game “distance.”

The “exchange rate” for the in-game currency may be based on individual physiological characteristics of each player such that the in-game currency is standardized.

The currency could have actual value because it represents an actual benefit conferred onto society, namely an increase in health and reduction in healthcare costs. It is also conceivable that the exercise machines could be coupled to power generation devices that convert work to electricity and input the energy into the grid. The currency could be used within the VE for various “in-game” benefits such as clothes for one's avatar, upgrades to in-game vehicles and the like. But because of the inherent value of the exercise credits, it is conceivable that they could be redeemed for other items of actual value.

### A Virtual [Gaming] Environment where User Exercise Provides Gaming Input

In an embodiment the invention is a virtual environment wherein real world user exercise provides input to the VE and where interactions in the VE provides feedback to exercising users. The VE may be a massive multiplayer online virtual reality exercise game (MMOVREG). Users may interact with the VE by using a variable resistance movement device (VRMD). In an embodiment, user movement on the VRMD may translate into movement in the VE. For example, a user may be on an elliptical machine operatively coupled to the VE. The user will be represented by an avatar in the VE. The user's avatar may take any form, as for example, an anthropomorphic character, animal, vehicle or the like. User motion on the VRMD may translate into motion in the VE. Interaction of the user's avatar with elements in the VE will translate to changes in resistance on the VRMD as well as other haptic feedback. Users may engage in any number of a variety of activities in the VE. For example, the VE may have various trails where users can enjoy exploring various environments. Users may use the trails alone or with other users. The VE may have arenas, or other defined environments for various game play such as capture the flag or any other game. The VE may have racetracks where users can race against other users or NPCs. Users may connect to the VE via any appropriate means known to those skilled in the art, as in for example, computers, video game consoles, the cloud and the like.

In other embodiments the user may take on human, animal or other avatars. For example, the in-game character may be a quadruped such as a lion. Movement of the exercise device may be so configured so as to mimic the motion of the quadruped. For such embodiments, exercises devices such as elliptical machines with arm movement may prove particularly useful. In such embodiments the arm levers may be capable of providing active force feedback, for example, actively pushing back on the hands/arms of the user. The in-game elements of the quadruped game may include running from predators and hunting. In the hunting embodiments the quadruped may be required to chase down and bring down prey. When bringing down prey, the exercise device's ability to provide active force feedback would mimic the action of grabbing and holding down prey.

Several methods of in-game control are contemplated. For example, speed of the in-game vehicle or avatar may be in direct proportion to the speed at which the user is operating the exercise device. Alternatively, the in game vehicle or avatar may be “powered” when the user provides a threshold amount of exercise input to the system. In such cases, in-game controls may rely on standard video game control methods such as the joystick or controller. In embodiments which integrate joysticks, controllers or the like, it is contemplated that additional control features would incorporate movement tracking, as for example, would be provided by the head mounted display or the motion tracking system [Kinect, Leap etc.] For example, in the vehicle embodiment, the vehicle may be fully powered when the user supplies a certain minimum energy input but control of the vehicle's speed will be determined by user input on the controller. For example by pushing a joystick forward. Alternatively, the speed of the vehicle may be determined in direct proportion to the user's input on the exercise device, but the control of the vehicles steering, altitude etc would be controlled by user input with the joystick. Weapons may be controlled by the joystick or a combination of motion tracking and the joystick or verbal commands. For example, “missiles” could be fired using a button on the joystick, but “guns” may be aimed by tracking the motion of a user's head and fired by inputting on the controller/joystick.

Spectator functions may be built into the virtual environment to allow others to watch the game play. Virtual “ride along” functionality may allow user's to witness the action from players' points of view. Alternatively the action could be captured from various vantage points to allow a varied spectator experience.

In an embodiment the invention is a massively multiplayer on line game (MMPOG) where players, situated anywhere in the world could meet in an online environment and play together. In one embodiment the networked players may meet to play a racing game.

### Control Interface for a Machine in a Virtual Environment

Visual anchor points on a real world control panel, as in for example a panel with buttons, used to provide a reference point to allow the projection of an control interface such as buttons into a virtual environment. See See 6057856 hereby incorporated by reference.

### EXAMPLES

### Example 0

A player is seated on a recumbent-bicycle style exercise machine. The exercise bike is equipped with a variable resistance mechanism under the control of a computer or processor. The bike can collect information regarding the output of energy from the player in various forms, including pedal strokes/min, rpm of a flywheel etc. The bike is operatively coupled to a computer [game console, cloud, pc, etc] such that the output of the bike can be integrated into the VE as, for example, in a game. In one embodiment, the VE is a game environment in the style of a racing game. Players speed would be determined as a function of their energy output on the bike. In other words, as a player pedals [exercises] faster, the player's in-game speed would increase. In addition the resistance mechanism on the bike would respond to game elements. For example, by increasing resistance during “uphill” portions of the race, or when the player goes off a designated path, and decreasing resistance on “downhill” portions of the race or when the player is “on” the designated in-game race course. Collision with in-game obstacles may also influence the resistance of the IRL exercise device. For example, collision with a wall, could make the exercise device lock up, or collision with a cactus, may increase resistance for a matter of seconds to indicate that the player has been “hurt.”

### Example 1

Player1 gets into his speeder bike. As he takes his seat a panel comes down over his legs sealing him into the cockpit. A message flashes across the heads up display across front panel of the cockpit's windshield informing him that his speeder bike is not powered up. The speeder bike instructs Player1 to input sufficient energy into to the system to initiate start up. Player1 begins to pedal. As he pedals a display on his cockpit dashboard tracks his progress. After about 2 minutes of pedaling an icon on his display lights up indicating that the speeder bike has sufficient power to run internal systems. Player1 says “power up internal systems.” The dashboard in front of him comes to life in a buffet of glowing dials and gauges. An icon on the cockpit's HUD indicates 3 new messages.

“Open message from Zero_Cool.” Player1 says, selecting the second message in the list. A window opens up on the HUD showing a text message comprising a few sparse lines. Full contact capture the flag tonight at 11:: Docking Bay 94. We're playing the Rangers, so bring your A game.

Player1 checked the clock on his display: 10:26. He'd have to hurry if he was going to make it on time. His speeder wasn't even powered up and Docking Bay 94 was at least a 15 minute ride. He checked the status of the power supply on his speeder bike. It was still only at 35%. It needed to be at least 50% to run the engines. He picked up the pace of his pedaling. Player1 had just started feel sweat slipping down his forehead when the gauge on his dashboard read 50% and changed from a glowing red to a glowing yellow.

“Power up engines” Player1 said. As he said the words, two icons on his display lit up showing that the speeder's twin engines were online. The seat rumbled and Player1 ears filled with the sound of the engines, something of a cross between the whine of a jet and the staccato beat of an old internal combustion engine. The speeder bike lifted off the ground and hovered about 6 feet in the air.

Player1 reached forward and tapped a map icon on his dashboard. A map appeared on his windshield showing Player1's position and the route to Docking Bay 94. The map showed a distance of 47 miles. Player1 put his right hand on the speeder bike's control stick and eased the bike forwards.

The Class 0 speeder bike used by Player1 was powered by reverse entropy engine. Simply put, for every unit of energy input to the system, the engine multiplied it by a factor of several orders of magnitude. In order to supply the necessary power to run the speeder's engines, Player1 had to keep the speeder's flywheel moving about 125 rpm. That speed kept his heart rate at about 110 bpm. In order to operate the bike at high speeds for extended periods of time his heart rate would climb to about 145 bpm. During the times where he had to run the bike at high speeds while powering weapons and shields, while at the same time dealing with, enemy strikes, his heart rate could climb to . . . well let's just say he was in for a workout. If he stopped pedaling with a full system, he would have about 3 or 4 minutes of stored power before the speeder powered down.

For now, Player1 felt himself relax into the flow of his pedaling and enjoyed the scenery as it flashed by. His route took him through the steam forests of Glendor, with their deep gorges and impossibly long rope bridges. A gust of wind shot through Player1's hair as he crested a hill and zipped through a glade of 700 foot tall redwoods. Using the joystick in his right hand, he maneuvered the speeder bike around the trees and over the boulders that littered the field. While the bike hovered easily, it wasn't much for altitude. At max speed, the Class zero speeder would shoot a few hundred yards into the air if the user pulled all the way back on the stick. Usually riders kept their bikes between 10 and 20 feet off the ground. It was most energy efficient that way.

After about 15 minutes of easy flying, Player1 arrived at the staging zone. The rest of his team were already there, hovering in a diamond formation outside the entry gate and powering up their rigs. Player1 pulled up and hover-parked his bike in position. He checked his gauges and the time. His overall power level was 88% with only 10% in his reserve capacitor. With only 10 minutes left before the first game started, he would be able to get his reserve power up to 25 or 30% max. It was going to be a tough match.

While Player1 was pedaling hard to power up the ancillary systems on the speeder, Player8 opened a chat line with the team and reviewed their strategy. Player1 watched the numbers climb on the display showing his heart rate. He wanted to get as much power into his system as possible but he didn't want to burn himself out for the game.

The contest that was about to begin was nothing more than a game of capture the flag. One team of players tries to find, remove and carry back to their home base, an opposing team's flag. The only difference was that this game of capture the flag was being played on Class_Zero flying speeder bikes capable of speeds in excess of 300 mph, equipped with energy and projectile weapons and being played in a closed arena larger than some cities.

Player1 sped up his pedaling as the time counted down to the gate of the arena being opened. The two teams had booked the arena for an hour. Docking Bay 94 wasn't cheap by any means but with 16 of them all chipping in, it was reasonable. The game would start as soon as the gate opened. With about half a minute left before the door opened, player8's voice came through, “Roll call.” he said. Each player checked in. “I hope you're up to this Player1.” Player8 said. “Roger that.” said Player1 as the gate cracked open on enormous pitted metal hinges.

As soon as was possible . . . the first two members of Player1's team shot forward through the giant metal doors and peeled off in hard, banking turns into the arena. The rest of the team followed suit, entering into the arena in pairs until they were all inside. Player1 pushed forward hard on the control stick and his speeder bike accelerated impossibly fast into the arena. Were it not for inertial dampeners build into the Class Zeroes, the he would have been ripped clean off the bike. Losing the feeling of g forces on acceleration and on hard turns took some of the fun away from the ride but, it was a small price to pay for not getting smeared across a boulder when you got hit with a concussion bolt.

Player one angled the front of his speeder up. The resistance on his pedals increased and he had to pedal harder to keep up his speed as he increased his altitude. As the speeder rocketed toward the center of the arena, Player one looked out to his right and left and saw his team form up around him in a defensive pyramid. By flying this way, they screened him not only from enemy fire but also from the buffeting effects of the wind. It allowed Player1 to keep up his speed and conserve some pedal power for what was coming.

Suddenly 6 flashing red icons appeared on his windshield display. “They're coming out to meet us.” Player 5 said over the radio. Sure enough the glimmering specs of 6 speeder bikes were just visible on the horizon. Players 2-6 sped up and to engage the six opposing players. Player one shot through the gap they created and sped onwards toward the enemy flag. “Activate cannon.” Player one spoke.

The cannon was mounted underneath the speeder and was coupled to the movements of Player1's head such that it was pointed at whatever Player1 looked at. A crosshair appeared on the windshield display indicating the weapon's aim point. Player1 banked to the left and looped back to the right, in his final approach to the enemy flag. As he approached he saw that two of the opposing teams players were circling the flag, guarding it. Player1 slowed his speed and dipped lower to stay out of sight. He zoomed his display and tracked the first enemy speeder. He matched the panning of his head with the speeder's motion until the cross hair was over the enemy speeder's engine. He squeezed the trigger on the control stick and the cannon spit a rapid fire burst of glowing green plasma bolts. Player1 saw the energy level of his system drop with the energy expenditure of the cannon.

The plasma bolts smashed into the speeder bikes engines with a bright purple flash and satisfying explosion. The bike toppled forward and lay useless on the ground. Player1 cranked his legs against the pedals and activated a turbo boost thrusting the bike forward over the downed and smoldering speeder bike toward the flag. As he flew over the flag, a clamp beneath the front fins of the bike pinched the flag, picking it up. Resistance on his pedals increased with the added resistance of the flag. Player1 wasted no time banking his speeder around and accelerating toward his base.

He was pedaling hard, knowing the other enemy player that was guarding the flag must be pursuing him. Player1 turned his head around to check. He did so just in time to see the burst of the cannon. Player1 pushed forward on the control stick dropping the nose of the speeder and executing a hard left turn. Nevertheless one of the enemy's cannon shots fried his number 2 engine. Player1 immediately felt the resistance on his pedals drastically increase and he had to fight hard to keep up his speed. An alarm went off along with a flashing heart icon indicating that his heart rate had exceeded 200 bpm.

### Example 2

Player one got on his mountain bike and pedaled up to the starting line of the track. With the crack of the starter pistol the players jammed down on their pedals and the bikes shot forward. Player1 made the hole shot and found himself ahead of the pack. The first part of the course was a flat section that quickly turned into a long, steady climb. As the grade of the incline steepened, Player1 felt the resistance on his pedals increase as he climbed the hill. As he crested the hill and started down the other side, he felt the resistance on his pedals decrease and the wind rush over his face as he picked up speed. The track snaked through a clearing. The track itself was hard packed gravel but to either side of the track was loose sand. If any of the players went of the track, the bikes would lose traction and their wheels would spin. The players could pedal hard but with such poor traction they would have the subjective experience of decreased pedal resistance but their speed would decrease. In other parts of the course, the track was flanked by other environmental hazards such as grass, when riders tried to pedal through the grass, resistance increased on pedals and it was harder to ride and gain/maintain speed. Occasional sections of TurboTrack could be found along the course. These sections of TurboTrack conferred a speed bonus [power up] to the first rider to traverse this section of track. The rider to cross the TurboTrack had the subjective experience of a reduction of pedal resistance on his bike and an increase in traction allowing that rider to speed up. This course was a “pure” course which meant that the bikes were not equipped with any weapons. Nevertheless there were other hazards. For example, in the forested parts of the course, monkeys hidden in the trees would throw rocks at the passing riders. Getting hit by a rock would increase the rider's pedal resistance for 30 seconds and cause a rumble in his seat.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein, including all patents, published patent applications, and published scientific articles, are incorporated by reference in their entireties for all purposes.

What is claimed is:

1. A virtual reality exercise videogame comprising:
A virtual reality environment further comprising at least one avatar representing at least one user, the virtual reality environment further comprising at least one collision object, and wherein the virtual reality environment further comprises collision detection, capable of detecting at least one collision between the at least one collision object and the at least one avatar representing at least one user and/or at least one collision between the at least one collision object with another at least one collision object and/or at least one collision between the at least one collision object and the virtual reality environment;
wherein the movement of the at least one avatar in the virtual environment is mediated, at least in part, by user input on a variable resistance exercise device, the variable resistance exercise device further comprising a resistance; and
wherein an at least one collision between the at least one collision object and the at least one avatar results in a change in the resistance on the variable resistance exercise device.

2. The virtual reality exercise videogame of claim 1 wherein the virtual reality environment is displayed to the at least one user on a head mounted display.

3. The virtual reality exercise videogame of claim 2 wherein the head mounted display is adapted for use during exercise.

4. The virtual reality exercise videogame of claim 1 wherein the at least one collision object is at least one virtual projectile launched from at least one virtual projectile launcher.

5. The virtual reality exercise videogame of claim 4 wherein the at least one virtual projectile launcher is coupled to the at least one avatar representing the at least one user in the virtual reality environment.

6. The virtual reality exercise videogame of claim 1 wherein the at least one collision object is a power-up.

7. The virtual reality exercise videogame of claim 1 wherein the at least one avatar representing the at least one user in the virtual environment is a collision object such that collisions between at least a first avatar and at least a second avatar can be detected.

8. A system for exercising in a virtual reality environment comprising:
At least one variable resistance exercise device for accepting at least one user exercise input, the at least one variable resistance exercise device having a resistance setting, the at least one variable resistance exercise device operatively coupled to a virtual reality environment rendered by a computing device such that at least one user exercise input on the variable resistance exercise device translates to movement of at least one avatar representing the at least one user in the virtual reality environment; and wherein the virtual reality environment further comprises at least one collision object capable of a collision with the at least one avatar representing the at least one user in the virtual reality environment; and wherein the collision of the at least one collision object with the at least one avatar representing the at least one user in the virtual reality environment causes the resistance setting of the at least one variable resistance exercise device to change.

9. The system of claim 8 wherein the virtual reality environment is displayed to the at least one user on a head mounted display.

10. The system of claim 9 wherein the head mounted display is adapted for use during exercise.

11. The system of claim 8 wherein the at least one collision object is at least one virtual projectile launched from at least one virtual projectile launcher.

12. The system of claim 11 wherein the at least one virtual projectile launcher is coupled to the at least one avatar representing the at least one user in the virtual reality environment.

13. The system of claim 8 wherein the at least one collision object is a power-up.

14. The system of claim 8 wherein the at least one avatar representing the at least one user in the virtual environment is a collision object such that collisions between at least a first avatar and at least a second avatar can be detected.

15. A stationary exercise station comprising:
A computer, the computer rendering a virtual reality environment, the virtual reality environment further comprising at least one avatar representing an at least one user, the virtual reality environment further comprising at least one collision object, the virtual reality environment further comprising collision detection capable of detecting at least one collision in the virtual reality environment;
A display in communication with the computer;
an exercise device capable of receiving exercise input from the at least one user, the exercise device further comprising a variable resistance mechanism, the variable resistance mechanism providing a resistance to the exercise input from the at least one user, the resistance having a magnitude, the magnitude of the resistance being controlled by the computer rendering the virtual reality environment; and
wherein a collision of the at least one avatar with the at least one collision object in the virtual reality environment cause the computer to alter the magnitude of the resistance of the variable resistance mechanism providing the resistance to the exercise input from the user.

16. The stationary exercise station of claim 15 wherein the display is a head mounted display adapted for use during exercise.

17. The stationary exercise station of claim 15 wherein the at least one collision object is at least one virtual projectile launched from at least one virtual projectile launcher.

18. The stationary exercise station of claim 17 wherein the at least one virtual projectile launcher is coupled to the at least one avatar representing the at least one user in the virtual reality environment.

19. The stationary exercise station of claim 15 wherein the at least one collision object is a power-up.

20. The stationary exercise station of claim 15 wherein the at least one avatar representing the at least one user in the virtual environment is a collision object such that collisions between at least a first avatar and at least a second avatar can be detected.
